(19) United States
(12) Patent Application Publication
(10) Pub. No.: US 2007/0144363 A1
(43) Pub. Date: Jun. 28, 2007

(54) Ball identification marking and monogramming tool

(76) Inventors: Francis C. Carroll, Philadelphia, PA (US); James J. Carroll JR., Richboro, PA (US)

Correspondence Address: Law Office of Jim Zegeer, Suite 108, 801 North Pitt Street, Alexandria, VA, 22314, US

(21) Appl. No.: 11/316,350

(22) Filed: Dec. 23, 2005

(51) Int. Cl. B41F 17/00

(52) U.S. Cl. 101/35

(57) ABSTRACT

A ball marking device in which a ball is easily loaded into and held in position in the device for marking and in which the selected character or indicia are easily loaded into the device.

### BACKGROUND AND BRIEF DESCRIPTION OF THE INVENTION

This invention relates to devices for marking balls with identification indicia such as a name or initials of the owner or other indica which is clearly visible and permanently recorded on the surface of a ball, particularly golf balls.

it is common practice for sports ball owners to place their initials or monograms or other identifying indicia on their sport balls. In the game of golf, for example, the owners frequently mark their golf balls with their initials or with stars or other identifying indicia. Many devices and techniques have been developed through the years to facilitate the marking of one's initials or monogram or identifying initials on a ball as reflected in the following prior art:

Published Applications
U.S. 2001/0053721 A1—Tyke
U.S. 2002/0005124 A1—Parks
U.S. 2002/0086741 A1—Newcomb
U.S. 2002/0139256 A1—Ramey
U.S. 2002/0189468 A1—Sosis
U.S. 2003/0022724 A1—Rennecamp
U.S. 2003/0109319 A1—Andresen
U.S. 2003/0153396 A1—Andresen
U.S. 2003/0181253 A1—Kim
U.S. 2005/0255940 A1—Tebbe

U.S. Patents
U.S. Pat. No. 849,600—Cory
U.S. Pat. No. 943,851—West
U.S. Pat. No. 952,501—Blumberg
U.S. Pat. No. 1,476,203—Horne
U.S. Pat. No. 1,537,861—Moffett
U.S. Pat. No. 2,002,847—Atti
U.S. Pat. No. 2,005,787—Humphrey
U.S. Pat. No. 2,593,212—Smith
U.S. Pat. No. 3,019,672—Hauntz
U.S. Pat. No. 4,086,851—Brandell
U.S. Pat. No. 4,803,922—Dennesen
U.S. Pat. No. 5,743,180—Arnke
U.S. Pat. No. 5,878,659—Hatter
U.S. Pat. No. 5,925,186—Klimek
U.S. Pat. No. 6,004,223—Newcomb
U.S. Pat. No. 6,209,452—Klimek
U.S. Pat. No. 6,216,587—Foley
U.S. Pat. No. 6,418,843—Givler
U.S. Pat. No. 6,453,807—Ramey
U.S. Pat. No. 6,595,128—Parks
U.S. Pat. No. 6,716,112—Rennecamp
U.S. Pat. No. 6,742,449—Sosin
U.S. Pat. No. 6,676,544—Tyke
U.S. Pat. No. 6,748,867—Kametani
U.S. Pat. No. 6,829,989—Chudy
U.S. Pat. No. 6,862,984—Sosin
U.S. Pat. No. 6,974,395—Rioux

Design Patents
U.S. Des. Pat. No. 497,948—Miller
U.S. Des. Pat. No. 508,078—Caramico

These prior art examples include fixed and adjustable print or stencil indicia, i.e. the identifying indicia or monogram is changeable. Some of these prior art include stencils for marking a golf ball for providing alignment aids for the golfer in accurately stroking the ball, in putting or driving situations.

The object of the present invention is to provide a ball marking device, especially a golf ball, which is easily loaded into and held in position in the device for marking. Another object of the invention is to provide a ball marking device in which the selected characters or indicia are easily loaded into the device.

According to the invention, the ball monogramming or indicia marking tool comprises a plastic housing having a ball receiving open end with a peripheral edge and a plurality of side-by-side windows. A plurality of alphabetic character or other identifying indica are formed as stencils in stencil carriers. The plurality of side-by-side windows are adapted to receive selected ball-identifying indicia, and each window is provided with means for interacting with the selected indicia stencil carrier to retain the selected indicia stencil in the given window. In a preferred embodiment of the invention, each stencil carrier is applied or plugged-in each window from the exterior of the housing. The peripheral edge of the housing has at least one narrow slot formed therein, and an elastic member is stretched across the slot and intrudes in the space of the open end of the housing shell. When the ball is pressed inside the open end of the housing, which is slightly larger in diameter than the ball, it displaces the elastic member(s) to one side to allow the ball to enter so that when the centerline or equator of the ball passes the stretched elastic member, the ball is retained in the housing in a position whereby the stencils can be traced with a tracing pen to thereby place the monogram and/or indicia of the user on the golf ball. This novel ball retention feature may be used in other ball marking devices where the stencil is integral with the housing. A further feature of the invention is that each window includes at least one rib and/or groove and a chamfered surface contiguous to the rib or groove, Each stencil carrier has a complementary groove or rib and a chamfered edge leading to the groove or rib so that when the stencil carrier is placed on the window pressed down, the chamfered edges cooperate to allow the ribs to enter the complementary groove to form an interference fit and latch the stencil carrier in the window. Another feature of the invention is that the peripheral edge of the housing has a plurality of slits and an elastic 0-ring or rubberband member seated in the slits such as to intrude in the opening thereby retaining the golf ball in the housing.

Furthermore, the invention provides a hemispheric plastic shell housing having a ball-receiving opening with a peripheral edge and a plurality of side-by-side windows. A set of alphabetic-indicia stencil carriers are provided to the user to select monogram indicia. Each window is adapted to receive a stencil carrier from the exterior of the housing from one or more stencil carriers and means in each window for interacting with each stencil carrier to retain the stencil carrier in a given window. The peripheral edge of the housing has a plurality of slits therein and an endless elastic member (similar to the 0-ring) is seated in the slit such as to intrude in said opening to thereby retain the golf ball in the housing.

### BRIEF DESCRIPTION OF THE DRAWINGS

The above and other objects, advantages and features of the invention will become apparent when considered with the following specification and accompanying drawings wherein:

FIG. 1 is a top perspective view of a ball identification and marking and monogramming tool incorporating the invention,

FIG. 2 is a bottom plan view of a ball identification marking and monogramming tool shown in FIG. 1,

FIG. 3 is a side perspective view of a molded plastic housing which in this perspective view is preferably a hemispheric shape,

FIG. 4 is a top perspective view of the housing shown in FIG. 1,

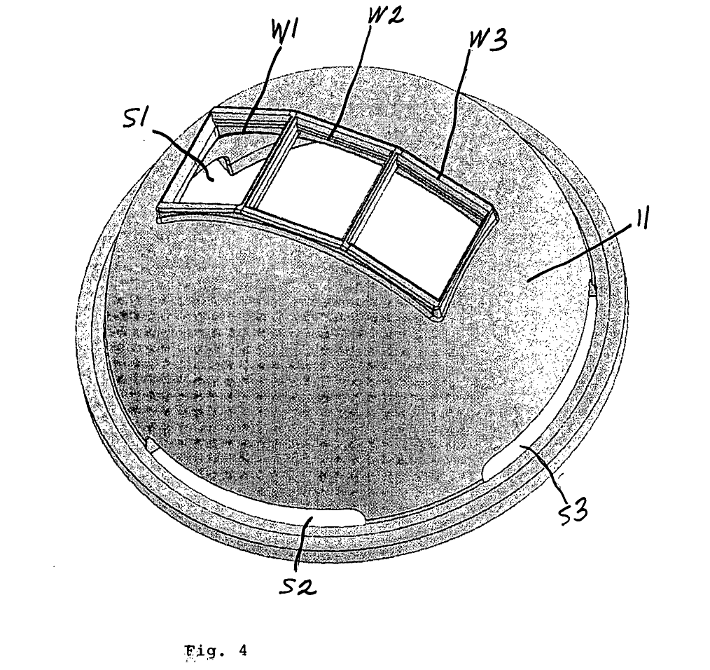

FIG. 5a is a plan view of the molded characters showing the mold tree connecting the individual stencil carriers with the stencils formed therein,

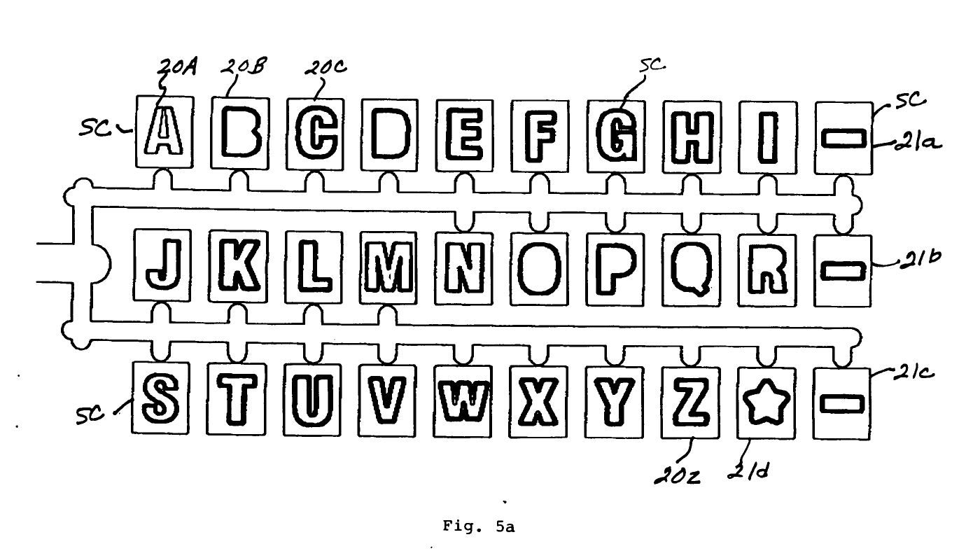

FIG. 5b is a perspective view of a stencil carrier with the character A,

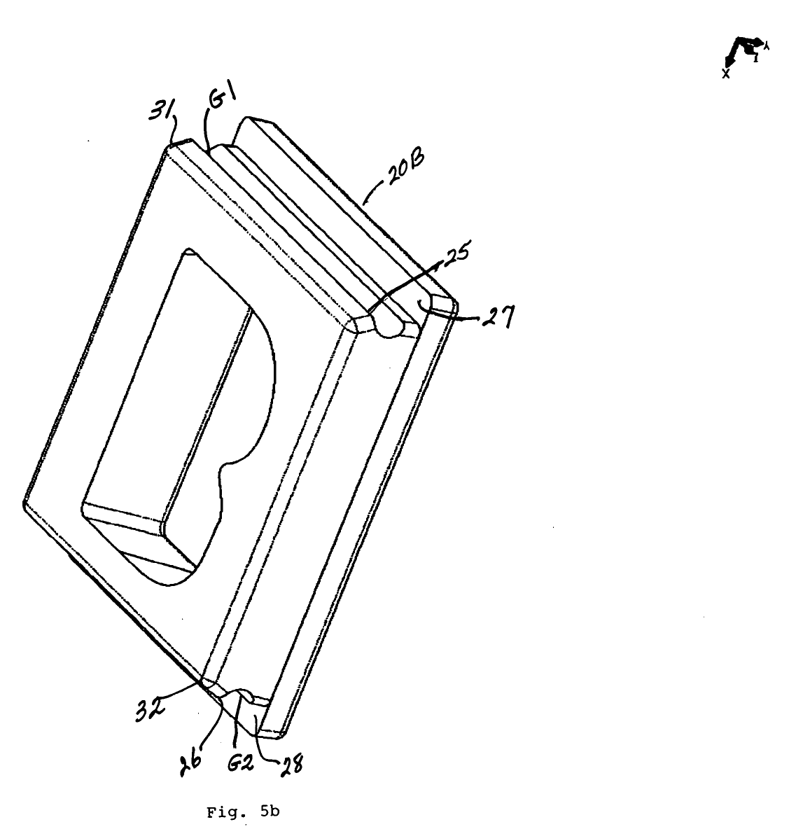

FIG. 5c is a rear perspective view of the stencil carrier for the stencil character B,

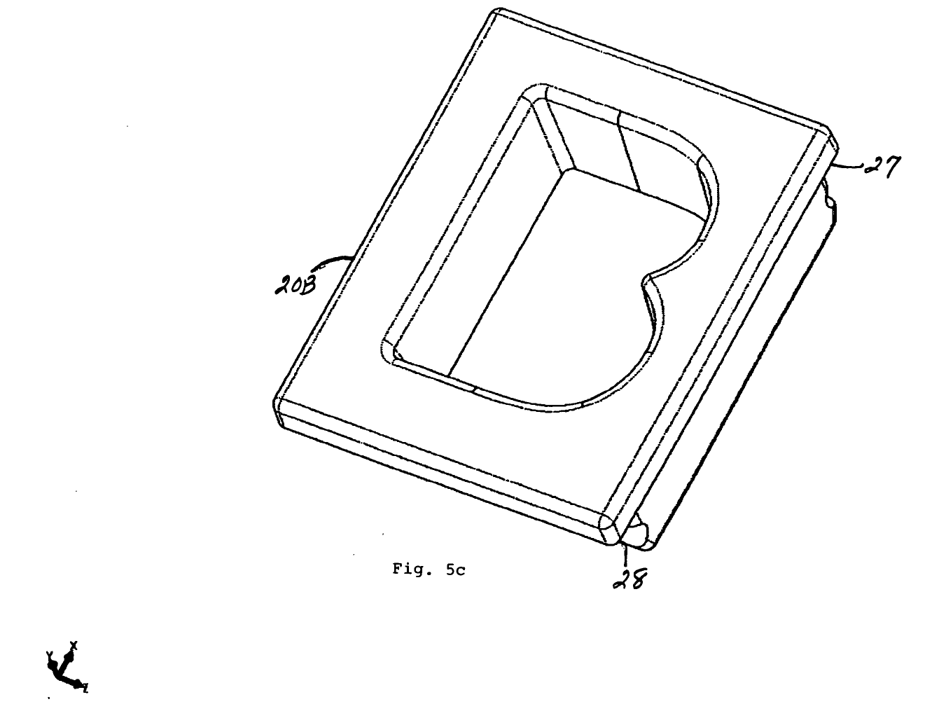

FIG. 5d is a front or top view of the stencil character B,

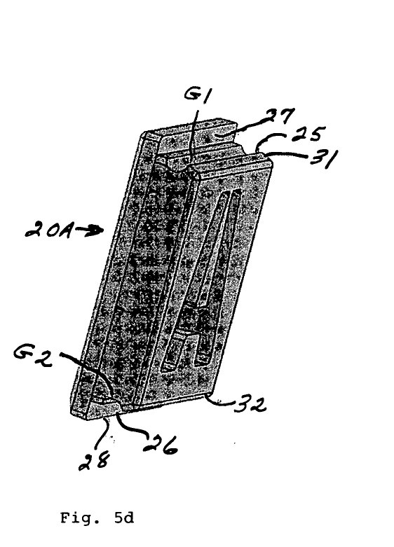

FIG. 6a is a side elevational, sectional view showing the character installed in place,

FIG. 6b is an enlarged view showing the character stencil and window construction details,

FIG. 7 is a perspective view showing the user holding the housing and ball in the left-hand fingers and inscribing or tracing the characters on a ball with a marking pen.

### DETAILED DESCRIPTION OF THE INVENTION

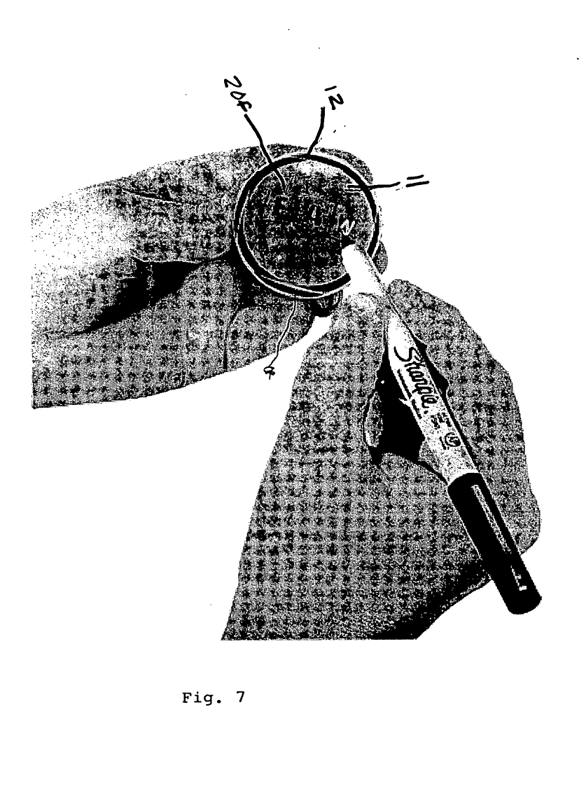

Referring to the drawings, the golf ball marking tool of the invention comprises a molded housing 10 having a hemispheric shape 11 in this preferred embodiment and has a lower peripheral edge 12 having a circular ring 12 for retaining an elastic member or O-ring so that the elastic member stretches across slots S1, S2, S3 and S4 thereby intruding in the space of the open end of the shell housing. The intruding portions OR-1, OR2, OR-3, OR-4 are displaceable by a golf ball GB to be inserted therein so that when the ball is going past the centerline thereof, the ball is retained in the inner shell in a position whereby the stencils can be traced with a tracing pen to thereby place the monogram or indicia of the user or owner on the golf ball as shown in FIG. 7.

A plurality of stencil windows W1, W2, W3 are formed for receiving the individual stencils S1, S2, S3. Although only one set of windows W1, W2, W3 is shown, it will be obvious that more or less windows may be molded into the housing for other characters and/or indica. For example, a set of stroke alignment stencils 21a, 21b and 21c may be provided. Numerical stencils may be provided. Moreover, although the windows are shown on the top surface of the hemisphere 11 for the alphabetic indicia, they can be located almost anyplace on the upper surface and they need not necessarily be in alignment.

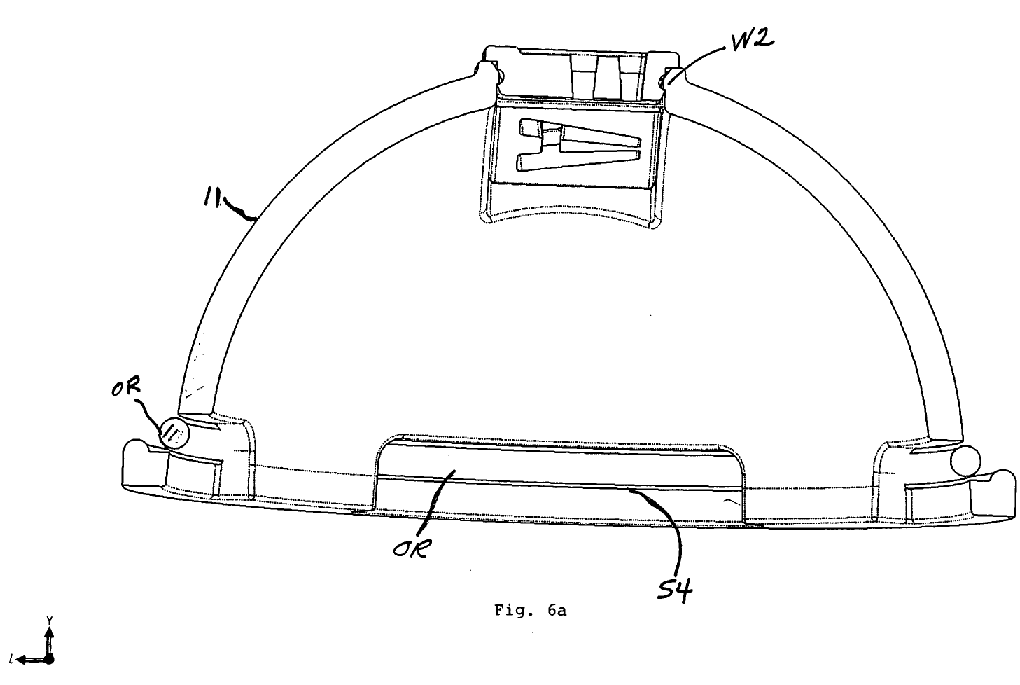

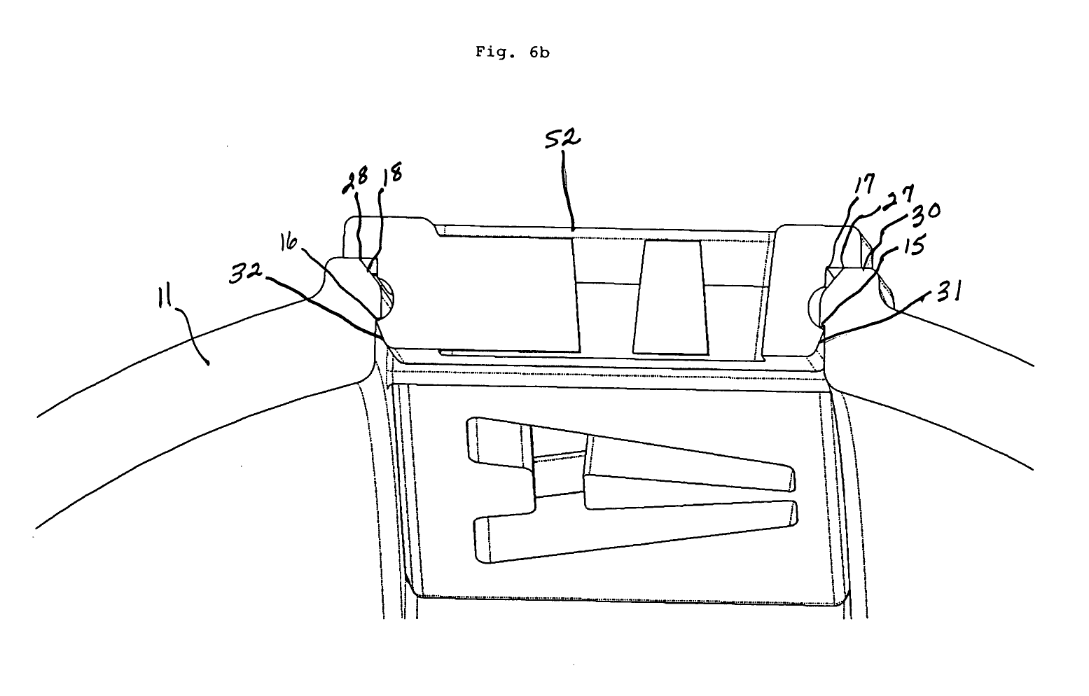

Each window W1, W2, W3 includes at least one latching rib or shoulder 15, 16 (see the enlarged sectional view of character stencil latched in place in FIG. 6b). Preferably, each latching shoulder or rib 15, 16 is preceded by a chamfered or beveled edge 17 and 18, respectively.

### The Individual Stencil Characters

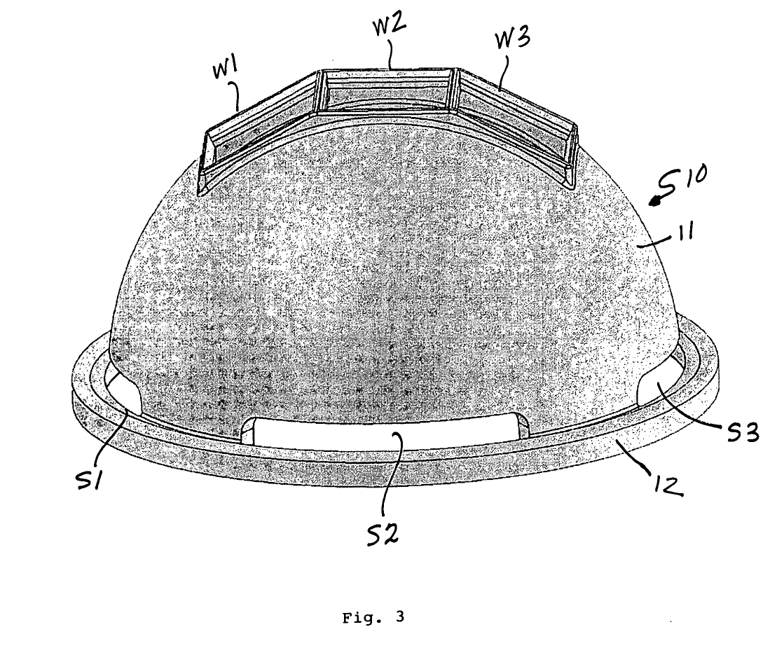

Referring to FIGS. 3a, 3b, 3c and 3d, the letters of the alphabet are formed in stencil carriers SC, and for the purpose of monogram, the letters or alphabetic characters A-Z are formed in stencil openings in stencil carriers 20a, 20b. . . 20z, constituting the 26 letters of the alphabet and additional indicia such as stars 21d, squares, straight lines. In stencil indicia blocks 21a, 21b and 21c are shown lines which may be lined up to draw or stencil alignment indica for ball stroking purposes, such as putting and driving alignment purposes. Referring to FIGS. 3b, 3c and 3d, the detailed construction of the individual stencil carriers is shown. Each stencil carrier has a pair of latchment edges 25, 26. The upper 25 and lower 26 latchment edges have a stop flange or shoulder 27, 28 which abut the upper surface 29 of the window 29, 30. Each character is installed, e.g. plugged in, either before or after the ball is in the housing, and are individually and accurately spaced in position by the windows W1, W2, W3. The grooves G1, G2 in each window block 20 is preceded by a bevel or chamfered edge 31, 32 to facilitate entry into the window in coaction with the window bevel or chamfered edges 17 and 18.

### Ball Retention

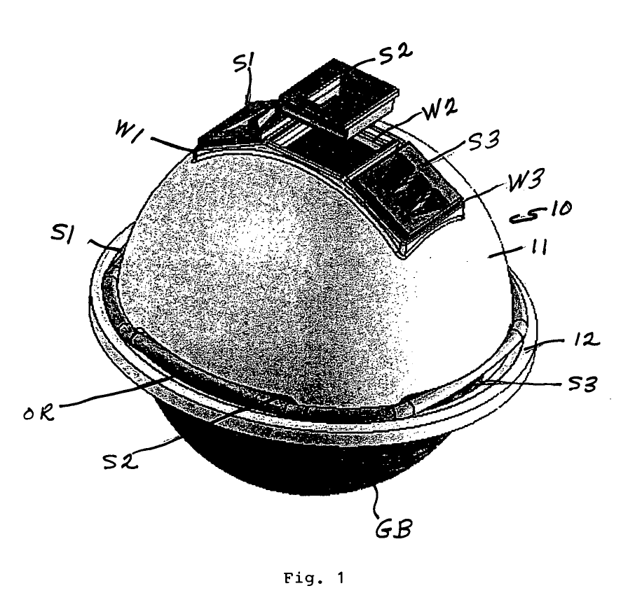

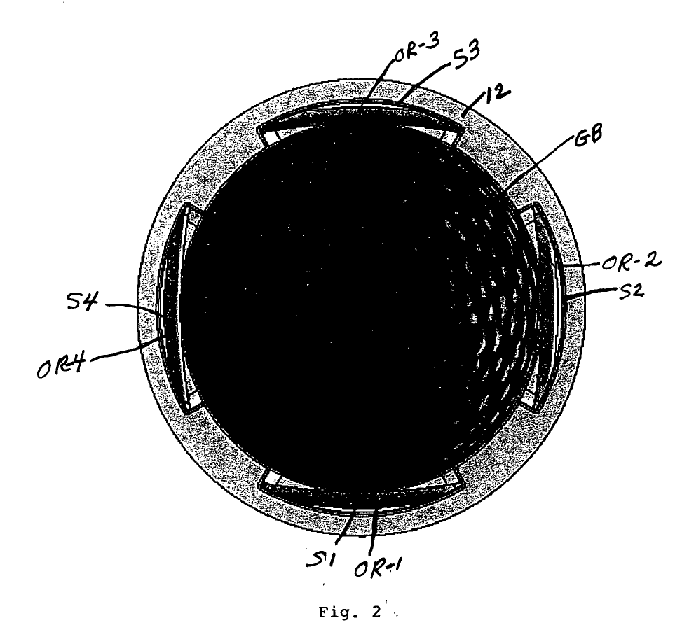

As shown in FIGS. 1 and 2 and the lower peripheral edge of the housing 11 is provided with a plurality of slits or slots S1, S2, S3 and S4 into which is fitted an O-ring 40 or other endless elastic member which stretches through and across each of the slots to intrude in the space of the open end of the housing and is displaceable by a ball inserted therein so that when the ball is going past the centerline thereof the ball is retained in the hemispherical shell in a position whereby the stencils can be traced with a tracing pen to thereby place the monogram or other indicia of the user on the golf ball.

### Ball Removal

The golf ball can be removed from the housing in a few different ways. The user can simply shake the ball out. He can use the tip of the marking pen to push the ball equator past the O-ring OR and it will fall out, or the housing can have one or more openings on either side of the three windows to push the ball out by using your fingers.

### SUMMARY OF THE INVENTION

Thus, there has been described a golf ball monogramming or marking tool comprising a molded, rigid plastic shell housing having a ball receiving open-end with a peripheral edge and a plurality of side-by-side windows, a plurality of character or indicia stencil carriers, each window adapted to receive a selected stencil carrier, means in each window for interacting with each stencil carrier to retain the stencil carrier in the given window, the peripheral edge of said hemispherical shell having at least one slot therein, and an elastic member stretched across the slot and intruding in the space of the open end of the shell. The stretched member is displaceable by a ball inserted therein so that when the ball goes past a centerline thereof the ball is retained in the hemispherical shell in a position whereby the stencils can be traced with a tracing pen to thereby place the monogram of the user on the golf ball. Further, the tool defined above wherein each window includes at least one rib and a chamfered surface contiguous to the rib, each stencil carrier having a complementary groove and a chamfered edge leading to the groove whereby when the stencil carrier is located in said window and pressed down the chamfered edges cooperate to allow the rib to enter the complementary groove to form an interference fit and latch said stencil carrier in said window. (The “rib” and “groove” can be reversed.)

The golf ball marking tool described above wherein the peripheral edge has a plurality of slits in said lower edge and an O-ring member seated in said slits such as to intrude in said opening thereby retaining the golf ball in said hemispherical shell when placed therein.

The invention also features a golf ball marking tool comprising a hemispheric plastic shell having a ball receiving open-end and a plurality of side-by-side windows, each window adapted to receive from the exterior of said hemispheric shell one or more plug-in indicia stencil carrier, means in each window for interacting with each said stencil carrier and retain said stencil carrier in the given window. The golf ball marking tool includes a ball retention system comprised of a plurality of slits in the peripheral edge therein and an endless extensible member seated in said slits such as to intrude in the opening thereby retaining the golf ball in the hemispherical shell.

While the invention has been described in relation to preferred embodiments of the invention, it will be appreciated that other embodiments, adaptations and modifications of the invention will be apparent to those skilled in the art.

1. A golf ball marking tool comprising a plastic shell housing having a ball receiving open-end with a peripheral edge and a plurality of side-by-side windows, a plurality of indicia stencil carriers, each window adapted to receive a selected indicia stencil carrier, means in each window for interacting with said each indicia stencil carrier to retain said indicia stencil carrier in a given window, the peripheral edge of said hemispherical shell having at least one slot therein, and an elastic member stretched across said slot and intruding in the space of said open end of said shell and displaceable by a ball inserted therein so that when said ball is going past a centerline thereof said ball is retained in said shell in a position whereby said stencils can be traced with a tracing implement to thereby place the indicia of the user on the golf ball.

2. The golf ball marking tool defined in claim 1 wherein each said window includes at least one rib and a chamfered surface contiguous to said rib, each said stencil carrier having a complementary groove and a chamfered edge leading to said groove whereby when said stencil carrier is located in said window and pressed down said chamfered edges cooperate to allow said rib to enter said complementary groove to form an interference fit and latch said stencil carrier in said window.

3. The golf ball marking tool defined in claim 1 wherein said peripheral edge has a plurality of slits in said lower edge and an O-ring elastic member seated in said slits such as to intrude in said opening thereby retaining a golf ball in said shell when placed therein.

4. The golf ball marking tool defined in claim 1 wherein said shell is hemispherical.

5. A golf ball marking tool comprising a hemispheric plastic shell having a stencil therein and a ball receiving open-end with a peripheral edge and a plurality of side-by-side windows, each window adapted to receive from the exterior of said hemispheric shell one or more alphabetic stencil carrier, means in each window for interacting with each said stencil carrier and retain said stencil carrier in a given window.

6. The golf ball monogramming tool defined in claim 5 wherein said peripheral edge has a plurality of slits therein and an endless extensible member seated in said slits such as to intrude in said opening thereby retaining the golf ball in said hemispherical shell.

7. A golf ball marking tool comprising a hemispheric plastic shell having a stencil therein and a ball receiving open-end with a peripheral edge, said peripheral edge having one of more slits therein and an endless extensible member seated in said slits such as to intrude in said opening thereby retaining a golf ball in said hemispheric shell.
